(19) United States
(12) Patent Application Publication
(10) Pub. No.: US 2010/0178402 A1
(43) Pub. Date: Jul. 15, 2010

(54) Method and Apparatus for Cooking Food and Sauces

(76) Inventors: Karolyn Ippolito, Trenton, NJ (US); Vincent Ippolito, Trenton, NJ (US)

Correspondence Address: MICHAEL J. HUEY, 378 South Branch Road, Suite 202, Hillsborough, NJ, 08844, US

(21) Appl. No.: 12/683,541

(22) Filed: Jan. 7, 2010

Related U.S. Application Data
(60) Provisional application No. 61/144,807, filed on Jan. 15, 2009.

(51) Int. Cl. A23L 1/01; B65D 33/06; B65D 33/00

(52) U.S. Cl. 426/412; 383/6; 383/207

(57) ABSTRACT

The invention relates to a variety of food, including frozen pasta sauce, packaged in a boilable pouch (“bag”) for food preparation. This invention teaches that sauce may be defrosted and heated thoroughly within a bag. By immersing the bag in boiling in water with other elements of the meal (e.g. pasta or other starch), multiple dishes may be cooked in the same pot of boiling water. The process includes packaging the frozen sauce in a vacuum-sealed boilable bag to form the packaged sauce. This present invention includes the manufacturing of frozen pasta sauce as well as to the heating of the sauce by end users (household consumers) in one pot together with pasta/starch or any other food capable of being cooked with boiling water (e.g. vegetables, meat, sausage etc.)—allowing for one pot preparation—“one pot prep.”

### CROSS REFERENCE TO RELATED APPLICATIONS

This application is related to, and claim priority from, U.S. Provisional Patent application No. 61/144,807 filed on Jan. 15, 2009 by Karolyn Ippolito and Vincent Ippolito entitled, “Method of Cooking Food and Sauces”, the content of which are hereby incorporated by reference.

### FIELD OF THE INVENTION

The present invention relates to a boilable bag useful for cooking various food and sauces in a single pot, methods for using the boilable bag, and use thereof in the preparation of food.

### BACKGROUND

Currently consumers must use a minimum of two (2) pots to cook pasta: one (1) for the sauce and one (1) for the pasta. The use of two pots increases the amount of energy consumed to cook, and to clean up.

Sauces are sold in jars, cans, or plastic containers. Sauce are typically poured into a pot and heated before it is served. Meanwhile, the pasta/starch is prepared in a separate pot of boiling water, cooking separately from the sauce until the sauce and pasta reaches a desired temperature and tenderness. If frozen sauce is used, it would typically be removed from its container, defrosted, and heated using either a pot or a microwave oven. Similarly, the pasta/starch is being prepared in a separate pot of boiling water, prior to mixing with the sauce. Each method mentioned above requires the end user to heat the sauce in a separate pot/container while cooking the pasta/starch in another, separate pot.

When all the sauce has been removed from the can, jar, or plastic container, the empty container is thrown away; consequently, consuming space and creating a burden on landfills. This invention offers an alternative for pasta and pasta sauce preparation that is not currently available in the market.

Our invention differs from existing cooking methodologies by allowing the consumer to cook both the pasta and sauce in one pot eliminating the need for the additional pot(s) thereby saving (a) the use of a separate pot for cooking the sauce; (b) cooking time; (c) clean up time; and, (d) recycling of the can, jar, or plastic container.

### SUMMARY OF INVENTION

Our invention is an alternative to the traditional method stated above by providing consumers with the ability to heat sauce and pasta/starch in the same pot of boiling water, thereby allowing for “one pot” food preparation. In one embodiment of the invention, sauce is first frozen and vacuumed sealed to maintain freshness and flavor, while inhibiting bacteria growth. A laminate is used to enclose the sauce, storing the sauce inside the bag until it is ready to be cooked. Layers of the laminate may be united by adhesive, pressure, heat, or combination thereof.

During the preparation of a meal, the frozen sauce is placed in a fluid (preferably water which has reached a rolling boil) until the sauce is defrosted (approximately 8 minutes for a 24 oz. package). The fluid may be a mixture of water and spices (e.g., salt and pepper).

Once defrosted the consumer may add a desired starch (e.g., pasta, rice) in the same pot with the sauce. In other words, both the sauce and pasta are heated in the same pot, together. Leaving the bagged sauce in the boiling water while the pasta cooks allows sufficient time for the bagged sauce to heat thoroughly. At the point of desired pasta/starch tenderness, the consumer removes the pasta and sauce from the boiling water.

The bag may be opened from its top end. The top end is distinguishable by a one inch handle above the seal on the bag. Because the handle is distally located from the food product, it cools significantly faster than the rest of the bag. Therefore, the handle can be handled almost immediately after removal from boiling water. The handle may vary in length depending upon the size, shape, and volume of the food contained in the bag. As mentioned, the purpose is to provide consumers with a suitable location to hold the bag while it is hot. As an alternative, the consumer may use tongs or gloves to hold the bag and/or handle.

The bag is cut from one corner with a knife or scissors. In another preferred embodiment, the bag has a precut slit or perforation to allow the consumer to tear open the bag by hand.

The sauce is poured over the pasta/starch. The sauce is then mixed with the pasta/starch and seasoned as desired.

The advantages of cooking sauce in a boilable bag are: (1) the elimination of the use of a second pot to defrost or heat multiple food items at once; (2) the sauce in the bag can remain in boiling water for an extended period of time without burning or reducing the flavor of the sauce inside; (3) no mess, the sauce remains contained in the bag until opened thereby eliminating sauce from drying or burning to the pot; (4) eliminate direct contact with pot thereby reducing the potential for burning or overcooking the sauce; (5) vacuumed sealed sauce is not subject to moisture loss or evaporation; (6) vacuum sealed bag eliminates freezer burn; (7) fresh cooked flavor; (8) more convenient way to store sauce; (9) more compact packaging; (10) more convenient way to cook sauce; (11) more environmentally friendly method of cooking because of less material being used to store the product—no glass jar or can to recycle; (12) reduced cooking time; (13) reduced clean-up time to wash burned sauce; reduced clean-up time to wash two pots.

The description of the structure, function, and methodological acts are not limited to the specific structures, function, or acts. Those of ordinary skill in the art may modify the embodiments, yet remain within the scope and spirit of the present invention.

### BRIEF DESCRIPTION OF THE DRAWINGS

This invention will be more clearly understood from the following description of some embodiments, given by way of example only, with reference to the respective accompanying drawings, in which:

FIG. 1 is a top perspective view of a boilable bag, identifying a handle, laminate, and frozen sauce.

FIG. 2A is another top perspective view of a boilable bag, identifying a handle, laminate, and frozen sauce.

FIG. 2B is a top view of a boilable bag, identifying a handle, laminate, and frozen sauce.

FIG. 2C is a side view of a boilable bag, identifying a handle, laminate, and frozen sauce.

FIG. 2D is a front view of a boilable bag, identifying a handle and frozen sauce.

FIG. 3 is a side view of a boilable bag, sauce, and pasta, placed within a pot of water.

FIG. 4 is a top perspective view of a boilable bag and cooked pasta sauce, identifying a pair of scissors cutting the bag. FIG. 4 also identifies a bowl containing pasta, which will receive the sauce.

FIG. 5 is a top perspective view a boilable bag with an opening that allows the sauce to exit the bag and poured over the pasta.

FIG. 6 is a flow chart identifying steps to utilize the invention.

### DETAILED DESCRIPTION

A preferred embodiment of the invention will be described in detail by reference to the accompanying drawing in which, as far as possible, like elements are designated by like numbers.

Although every reasonable attempt has been made in the accompanying drawing to respect the various elements of the embodiments in relative scale, it is not always possible to do so with the limitations of two-dimensional paper. Accordingly, in order to properly represent the relationship among the various features in the depicted embodiments and properly demonstrate the invention in a reasonably simplified fashion, it is necessary at times to deviate from absolute scale depiction in the attached drawings. However, one of ordinary skill in the art would fully appreciate any such scale deviation as not limiting the enablement of the disclosed embodiments.

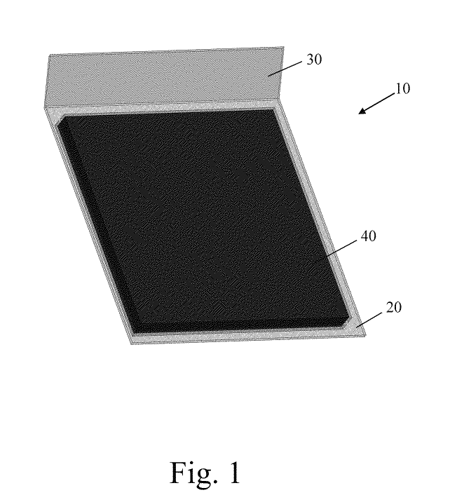

FIG. 1 is a top perspective view of a boilable bag 10, identifying a laminate 20, handle 30, and frozen sauce 40. The bag 10 is capable of storing various foods that include vegetable, pasta, rice, and sauces. In a preferred embodiment, sauce 40 is vacuum sealed inside the bag 10 to create an air tight barrier, which helps to maintain the “fresh cooked” flavor, while inhibiting bacteria growth. This is a convenient way to store sauce 40, frozen or refrigerated, in a compact package until use. The bag 10 is more environmentally friendly, reducing the amount of material used to store food or sauce 40—no glass jar.

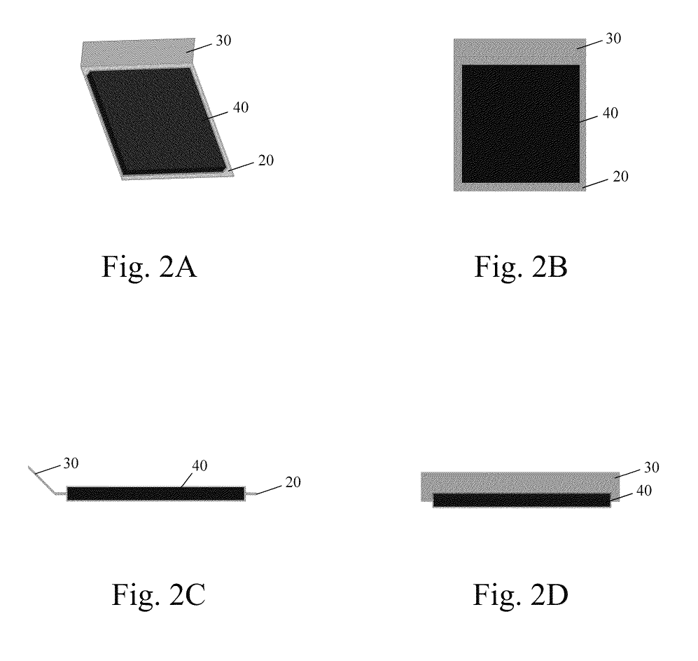

FIG. 2A is another top perspective view of a boilable bag 10, identifying a laminate 20, handle 30, and frozen sauce 40. The bag 10 is made of a material that has the capacity to withstand and tolerate boiling temperatures of water 50. Such material includes various heat-resistant plastics such as polycarbonate, polypropylene, nylon, and acrylic.

FIG. 2B is a top view of a boilable bag 10, identifying a laminate 20, handle 30, and frozen sauce 40. The handle 30 may be any length that allows a person to pick-up the bag 10 from a pot 60 of boiling water 50 without immersing their fingers in such water 50. In a preferred embodiment, the handle 30 is approximately 1 inch. The laminate 20, created though the use of adhesive or heat, enclosed various foods within the bag 10. In a preferred embodiment, the food is vacuumed sealed to create an air tight barrier.

FIG. 2C is a side view of a boilable bag 10, identifying a laminate 20, handle 30, and frozen sauce 40.

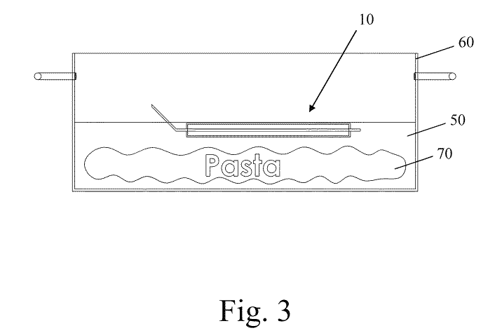

FIG. 2D is a front view of a boilable bag 10, identifying a handle 30 and frozen sauce 40. These views depict the handle 30 extruding at an upward angle, facilitating the pick-up of the bag 10. FIG. 3. further illustrations, the handle 30 extending past the surface of the boiling water 50. Consequently, the handle 30 is cooler, thereby providing a person with a means to pick-up the bag 10 without burning their fingers.

FIG. 3 is a side view of a boilable bag 10, frozen sauce 40, and pasta 60, placed within a pot 60 of water 50. This invention enables the cooking of the frozen sauce 40 without intermingling with the pasta 60. As such, no second pot 60 is required for defrosting/heating the food. Another advantage of the boilable bag 10 is the even, thorough, and quick heating of the sauce 40. Sauce 40 in the bag 10 can be immersed in boiling water 50 for an extended period of time without burning or reducing the flavor of the sauce 40 inside. The sauce 40 remains contained within the bag 10, thereby, minimizing the evaporation of the sauce 40 and preventing the sauce from drying or burning to the pot 60. Because the sauce 40 is vacuumed sealed inside the bag 10, there is no moisture loss or evaporation. This enhances the quality and flavor of the sauce 40.

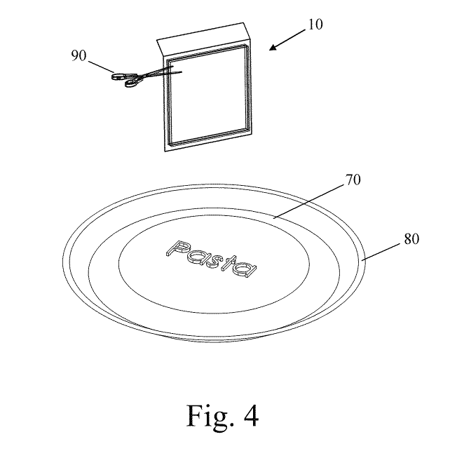

FIG. 4 is a top perspective view of a boilable bag and cooked pasta 60 sauce 40, identifying a pair of scissors 90 cutting the bag. In a preferred embodiment, the laminate 20 has a slit 100 that facilitate the ripping of the plastic, eliminating the need for scissors 90. FIG. 4 also identifies a bowl 80 containing pasta 60 that will receive the cooked sauce 40.

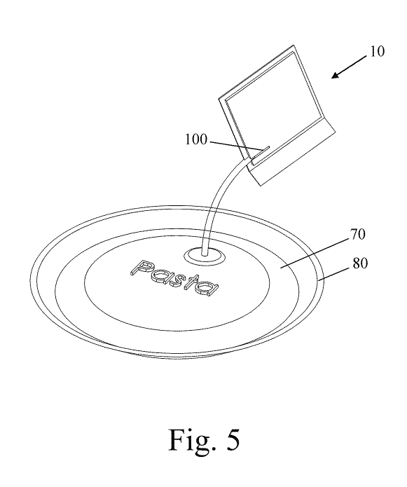

FIG. 5 is a top perspective view a boilable bag 10 with an opening that allows the undiluted and freshly cooked sauce 40 to exit the bag 10. The sauce 40 may be poured directly over the pasta 60. Once the contents of the bag 10 has been emptied, clean up is easy. Simply dispose of the bag 10. There is no sauce pot 60 to clean. The single cooking pot is relatively clean because burnt sauce 40 and spices did not accumulate on the pot.

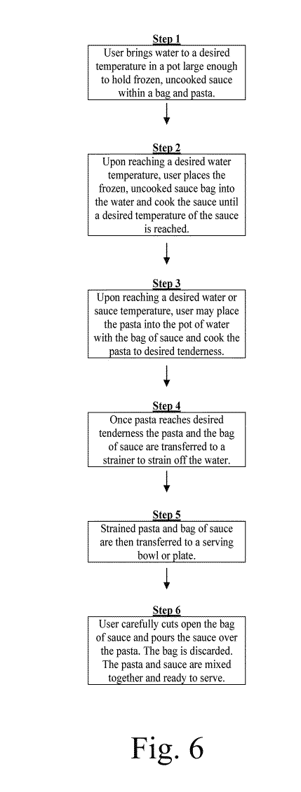

FIG. 6 is a flow chart that describes another preferred embodiment of the invention, identifying steps to utilize the invention.

What is claimed is:

1. An apparatus for cooking food comprising:
a) a boilable bag, wherein the bag is useful for storing or cooking food; and,
b) a laminate, wherein the laminate forms an enclosure to keep food within the bag.

2. The apparatus of claim 1 further comprising:
a handle attached to the bag, wherein the handle facilitates pick-up of the bag when the bag is immersed in boiling water or holding of the bag when its content is hot;

3. The apparatus of claim 1 further comprising:
A handle attached to the bag, wherein the a handle is 0.1 to 6 inches;

4. The apparatus of claim 1, wherein the boilable bag is made of material such as heat-resistant plastic, polycarbonate, polypropylene, nylon, and acrylic;

5. The apparatus of claim 1, wherein the laminate contains means for opening the bag;

6. The apparatus of claim 1, wherein the laminate contains a slit or perforation that allows the consumer to tear open the bag by hand;

7. The apparatus of claim 1, wherein the food is a frozen sauce.

8. The apparatus of claim 1, wherein the food is an unfrozen sauce.

9. A method for cooking, comprising:
a) Placing unheated first food in a bag, wherein the bag comprise of a material capable of maintaining its integrity at temperatures useful for cooking food;
b) Sealing the bag under a vacuum;
c) Adding the first food in the bag to a fluid;
d) Adding a second food to the fluid, wherein the first food and second food are in the same cooking container such as a pot; and,
e) Heating the first food and second food in the fluid.

10. The method in claim 9, wherein the first food is a frozen sauce.

11. The method of claim 9, wherein the first food is an unfrozen sauce.

12. The method in claim 9, wherein the second food is a starch, such as pasta, rice, oatmeal, grits, or other types of carbohydrates.

13. The method in claim 9, wherein the fluid is water.

14. The method in claim 9, where the fluid is water, spices, oil, or combination there of.

15. A method of cooking, comprising:
a) Transferring an uncooked or frozen sauce into a bag that has the capacity to withstand/tolerate boiling temperatures of water;
b) Heating water to a desired temperature in a pot large enough to cook a desired amount of pasta;
c) Placing the bag into the water, when the water has reached a desired temperature;
d) Cooking a sauce within the bag to a desire temperature;
e) Adding a second food into the same pot with the bagged sauce, when the water reached a desired temperature;
f) Cooking the second food to a desired temperature;
g) Opening the bag; and,
h) Adding the sauce in the bag to the second food.

16. The method in claim 15, wherein the bag is vacuum sealed.

17. The method in claim 15, wherein the sauce is tomato sauce or gravy, wherein the sauce or gravy may be frozen or unfrozen.

18. The method in claim 15, wherein the second food is a starch, such as pasta, rice, oatmeal, grits, or other types of carbohydrates.

19. The method in claim 15, wherein the fluid is water.

20. The method in claim 15, wherein the fluid is water, spices, oil, or combination there of.
